(19) United States
(12) Patent Application Publication
(10) Pub. No.: US 2014/0295773 A1
(43) Pub. Date: Oct. 2, 2014

(54) TRANSMITTER FOR WAKING UP ELECTRONIC SYSTEMS, RECEIVER, AIRCRAFT AND SPACECRAFT AND METHOD

(71) Applicant: AIRBUS OPERATIONS GMBH, Hamburg (DE)

(72) Inventors: Georg BÖCK, Berlin (DE); Alexander KRAVETS, Berlin (DE); Heiko TRUSCH, Wedel (DE)

(73) Assignee: AIRBUS OPERATIONS GMBH, Hamburg (DE)

(21) Appl. No.: 14/243,163

(22) Filed: Apr. 2, 2014

Related U.S. Application Data
(63) Continuation of application No. PCT/EP2012/068635, filed on Sep. 21, 2012.
(60) Provisional application No. 61/543,458, filed on Oct. 5, 2011.

(30) Foreign Application Priority Data
Oct. 5, 2011 (DE) 10 2011 084 049.4

(51) Int. Cl. H04W 52/02; H04B 1/68

(52) U.S. Cl. CPC H04W 52/0235; H04B 1/68; H04W 52/0229
USPC 455/68; 455/127.5; 455/130; 455/98

(57) ABSTRACT

The present disclosure pertains to a transmitter for waking up electronic systems with a first signal generator which is designed to generate a carrier signal with a first frequency, a second signal generator which is designed to generate an informational signal with a second frequency, a single-sideband modulator which is designed to modulate the information signal by the carrier signal, and a transmission device which is designed to emit the generated carrier signal and the modulated information signal. The present disclosure also pertains to a receiver, an aircraft and spacecraft and a method.

### CROSS-REFERENCE TO RELATED APPLICATIONS

This application is a continuation of and claims priority to International Patent Application No. PCT/EP2012/068635, filed Sep. 21, 2012, which claims the benefit of and priority to U.S. Provisional Application No. 61/543,458, filed Oct. 5, 2011 and German Patent Application No. 10 2011 084 049.4, filed Oct. 5, 2011, the entire disclosures of which are herein incorporated by reference.

### TECHNICAL FIELD

The present invention relates to a transmitter for waking up electronic systems, a receiver for electronic systems, an aircraft and spacecraft and a method for waking up an electronic system.

Although it may be used on any electronic systems, the present invention and the underlying problems are explained in detail with respect to electronic systems in aircraft and spacecraft.

### BACKGROUND

When developing electronic systems in aircraft, one of the development engineer's development aims is to minimise energy consumption by electronic systems. This has high priority, especially in electrical systems which have an autonomous power supply and which obtain the power required for operation from batteries or by means of energy harvesters.

Operation of this kind with autonomous power is advantageous for radio sensors which are arranged in wireless sensor networks, for example.

In order to reduce the energy requirements of such electronic systems, these may, for example, be operated on a cyclical basis. In this process, the electronic systems are switched on or off in cycles in order to save electrical energy when operation of the electronic system is not required and in order to operate the electronic system when necessary.

To enable an electronic system to be operated in a cyclical operating mode of this kind, the electronic system needs to be told when operation of the electronic system is necessary. For example, an electronic system may be switched on or off by a timer.

If an electronic system is switched on or off by a timer, it is not always possible to respond to any exceptional circumstances which may arise and which may require the electronic system to operate.

To enable the electronic system to operate even in such exceptional circumstances, for example, the electronic system may be woken up by a radio signal, and in particular a radio wake-up signal, for example. To allow them to be woken up by a radio signal, electronic systems in turn require a receiver which detects the radio signal and then wakes up the entire electronic system.

The tcm182 wake-up receiver from the Fraunhofer Institute for Integrated Circuits (IIS) is an example of a suitable radio receiver and this requires approximately 10 μm power and has a sensitivity of −60 dBm with a frequency of 868 MHz.

The tcm182 wake-up receiver can operate for approximately two years using a type CR2032 button cell battery.

A wake-up receiver is also disclosed in WO 2009/078600 by way of example.

### SUMMARY

A novel transmitter and related method are disclosed for waking up electronic systems, a receiver for electronic systems, an aircraft and spacecraft and a method for waking up an electronic system.

### BRIEF DESCRIPTION OF THE DRAWINGS

The invention is explained below in greater detail with the aid of embodiments and with reference to the attached figures in the drawing.

The figures show:

FIG. 1 a block diagram of an embodiment of a transmitter according to the invention;

FIG. 2 a block diagram of an embodiment of a receiver according to the invention;

FIG. 3 a block diagram of an embodiment of an aircraft and spacecraft according to the invention;

FIG. 4 a flow chart for an embodiment of a method according to the invention; and

FIG. 5 a block diagram of another embodiment of a receiver according to the invention.

In the figures, the same reference numerals refer to the same components or components with the same function, unless otherwise specified.

### DETAILED DESCRIPTION

One feature of the present invention is to reduce the energy requirements of an electronic system even more and to make it possible to address a large number of electronic systems with one wake-up signal.

A transmitter is disclosed for waking up electronic systems comprising a first signal generator which is designed to generate a carrier signal with a first frequency, a second signal generator which is designed to generate an is informational signal with a second frequency, a single-sideband modulator which is designed to modulate the information signal by the carrier signal, and a transmission device which is designed to transmit the generated carrier signal and the modulated information signal.

A receiver is disclosed for electronic systems comprising a mixing device which is designed to mix a received radio signal with itself and to emit a mixed radio signal, a demodulator which is designed to demodulate the emitted mixed radio signal and emit a demodulated radio signal, and an address decoder which is designed to compare the demodulated radio signal with a predefined address code and emit a wake-up signal if the demodulated radio signal displays the predefined address code.

An aircraft or spacecraft is disclosed with at least one transmitter and with at least one electronic system which comprises a receiver.

A method is disclosed for waking up an electronic system, especially in the aeronautics or aerospace industry, comprising steps such as providing a transmitter according to the invention, providing a receiver according to the invention, emitting a carrier signal and a single-sideband modulated information signal, receiving a radio signal which comprises the emitted carrier signal and the modulated information signal, mixing the received radio signal with itself, demodulating the self-mixed radio signal, comparing the demodulated radio signal with a predefined address code and emitting a wake-up signal if the demodulated radio signal displays the predefined address code.

The fact underlying the present disclosure is that evaluation of a radio signal modulated in the usual manner in the receiver requires a complex electronic evaluation system. Such an electronic evaluation system increases the energy is required by the receiver.

The concept underlying the present disclosure entails taking this fact into consideration and providing an opportunity for a radio signal to wake up an electronic system to be evaluated without the need to use such a complex electronic system.

To this end, a radio signal is emitted which comprises both a carrier signal with a first frequency and an information signal with a second frequency which has been modulated by the carrier signal. Single-sideband modulation of the information signal by the carrier signal is proposed in particular. Such an information signal can be reconstructed with itself in the receiver by simple mixing of the received radio signal which comprises both the information signal and the carrier signal.

If the information signal is modulated by the carrier signal by single-sideband modulation, the information signal is moved to a frequency within the frequency range which is in the region of the sum of the first frequency and the second frequency and this corresponds to the upper sideband from traditional frequency mixing. Due to the property of single-sideband modulation, whereby only one of the sidebands resulting from frequency mixing is emitted, the lower sideband which equates to the first frequency minus the second frequency is not generated. If the received radio signal is then mixed with itself, the information signal is moved directly back to the second frequency and can then be processed further.

If, as described above, a carrier signal and an information signal are emitted to wake up an electronic system, the bandwidth of the emitted signals is substantially determined by the bandwidth of the information signal. If address is codes are to be transmitted in the information signal, for example, in order to identify the electronic system to be woken up, the information signal can be adapted to the number of electronic systems to be addressed. In particular the information signal can be provided with a bandwidth of from 500 Hz to 10 kHz, and also in particular from 1 kHz to 5 kHz and 1 kHz to 2 kHz.

In addition, the first frequency and the second frequency can also be selected in virtually any ranges which seem appropriate for the respective application. In particular, the first frequency can also be between 1 GHz and 10 GHz, between 3 GHz and 7 GHz and 4.3 GHz. The second frequency can be between 1 MHz and 1 GHz, particularly between 10 MHz and 200 MHz from the first frequency. Other figures for the first frequency and the second frequency are also possible.

Electronic systems can be deliberately and very reliably woken in accordance with the present invention. In order to cause an electronic system to be woken by mistake with the present invention, interference signals would have to be received by the receiver in a very narrow frequency range around the first frequency and the second frequency. In addition, the interference signal for the second frequency would also have to display the address code of the electronic system receiving the interference signals. The present disclosure therefore also offers the advantage that it is very unlikely that electronic systems will be woken by mistake.

Advantageous embodiments and improvements of the invention are described in the sub-claims.

According to a development, the second signal generator is designed to generate the information signal at least in accordance with an address code and/or a channel number and/or a time slot number and/or an access code. If it is possible to provide a wide range of information in the information signal, important operating parameters can be communicated to the electronic system, for example, for radio data transmission even before the start of radio data transmission. This thus makes it faster and safer to establish a connection.

According to another development, the second signal generator is designed to generate the information signal by frequency modulation and/or amplitude modulation and/or an analogue modulation method and/or a digital modulation method. If different modulation methods are provided to imprint data in the information signal, the information signal can be flexibly adapted to the requirements of different applications. In particular, both bandwidth restrictions due to the usage environment and the required data transmission rate can be taken into account in this process.

According to another development, the demodulator is designed as a detector receiver and/or a discriminator and/or another demodulator. In particular the demodulator is designed such that it is able to demodulate the information signal generated by frequency modulation and/or amplitude modulation and/or an analogue modulation method and/or a digital modulation method.

According to a further development, the mixing device comprises a non-linear electrical component, e.g. a diode, and in particular a Schottky diode, and/or a field-effect transistor with one input and/or a field-effect transistor with two inputs. If a mixing device is provided which consists merely of passive electronic components, this makes it possible to keep the receiver's energy consumption low.

According to a further development, an antenna is provided to receive the radio signal which comprises a carrier signal with a first frequency and an information signal with a second frequency which is modulated by the carrier signal by single-sideband modulation. In addition or alternatively a first filter is also provided in front of the mixing device, this filter is filtering the received radio signal such that the received filtered radio signal comprises at least the carrier signal and the single-sideband modulated information signal. If a dedicated antenna is provided to receive the radio signal, this antenna may in particular be adapted to receive signals at the first frequency and the second frequency. The reception performance of the receiver can thus be increased.

If the first filter is provided, the signal which must be processed in the receiver can be restricted to the relevant frequency ranges before mixing with itself. Interference contained in the radio signal is thus eliminated at an early stage and it is possible to recognise the information in the information signal with certainty.

According to a further development, a second filter is provided between the mixing device and the demodulator, this filter being designed to filter the mixed radio signal in such a way that a filtered radio signal at least comprises the information signal with the second frequency. When the filtered radio signal is mixed with itself, further mixing products in addition to the information signal with the second frequency may result as a function of the mixing device. If a second filter is provided which merely allows signals in the interesting frequency ranges to pass through, these undesirable mixing products can be eliminated. This permits certain recognition of the information contained in the information signal.

According to a further development, a first amplifier is also provided between the mixing device and the demodulator, this amplifier being designed to amplify the mixed radio signal. If the mixed radio signal is amplified, is demodulation of the mixed radio signal is facilitated as the sensitivity of the demodulator can be lower than without amplification due to the amplified signal level.

According to a further development, a second amplifier is provided between the demodulator and the address decoder, this amplifier amplifying the demodulated radio signal in such a way that the demodulated radio signal can be evaluated by the address decoder. Such an amplifier makes it possible to evaluate the information signal with certainty. The second amplifier also makes it possible to adjust the signal between the demodulator and the address decoder if this is designed for different signal levels, for example.

According to a further development, a low-energy clock generator controls the receiver and activates this in a fixed clock ratio. In particular, the time during which the receiver is deactivated is longer than the time during which the receiver is activated. In this case the receiver can respond more quickly to wake-up signals the more often it is switched on. The clock ratio for switching on the receiver can therefore be optimised and adjusted according to the respective application.

According to a further development, components of the receiver can remain in a low-energy state until they detect a signal at their input. Only then do the respective components switch to normal operation and process the respective signal. The energy required by the receiver can thus be further reduced.

According to a further development, the receiver's receiving antenna may also be used as an antenna for data transmission for the electrical system. The first filter may also be used either in addition or alternatively for data transmission for the electrical system. This thus makes it possible to reduce the complexity and costs of the electrical system.

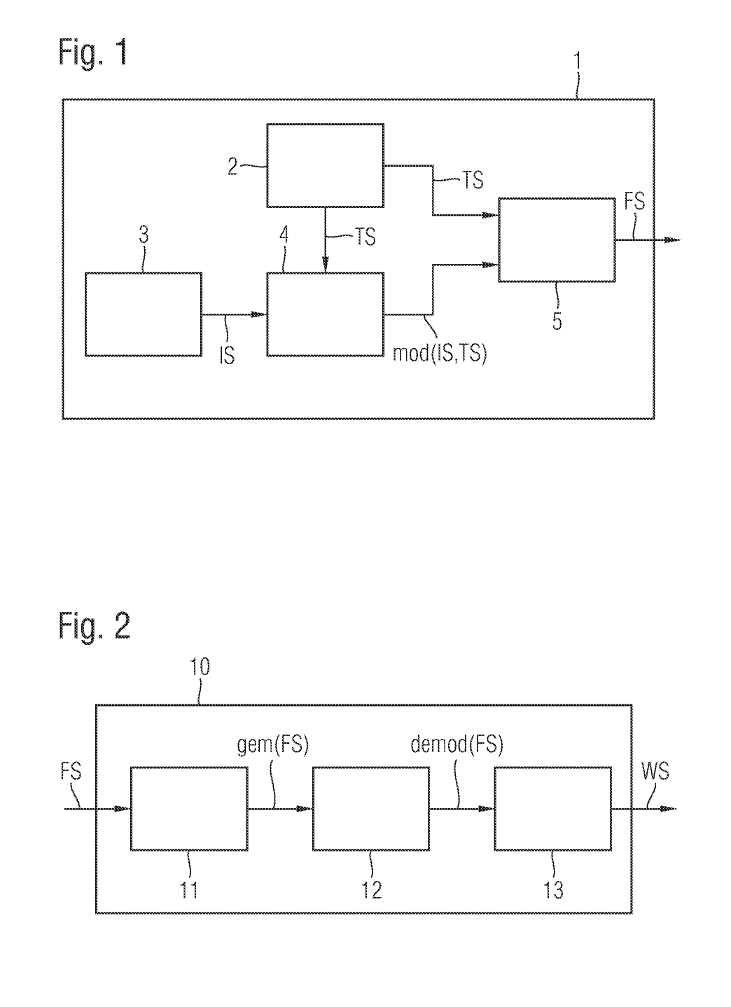

FIG. 1 shows a block diagram of an embodiment of a transmitter 1 according to the invention.

The transmitter 1 comprises a first signal generator 2 which is designed as an oscillator 2 with a fixed frequency and issues a carrier signal TS. The transmitter 1 also comprises a second signal generator 3 which is designed as an AM modulator 3 and emits an information signal IS. A single-sideband modulator 4 generates the modulated information signal mod(IS, TS) from the information signal IS by the carrier signal TS using single-sideband modulation. Finally, a transmission device 5 emits the carrier signal TS and the modulated information signal mod(IS, TS) as a radio signal FS.

In FIG. 1 the AM modulator 3 generates the information signal IS in which a small amount of data is imprinted by amplitude modulation. This data includes the address code of an electronic system to be woken up. In further embodiments more data may be imprinted in the information signal IS. Such data may, for example, include a channel number, time slot number, access code or similar. For example, data which defines parameters for radio communication with the electronic system to be woken up may be imprinted in the information signal IS.

In further embodiments, the second signal generator 3 is designed as an FM modulator 3 or as any other modulator 3 which is suited to imprinting data on the information signal IS.

FIG. 2 shows a block diagram of an embodiment of a receiver 10 according to the invention.

The receiver 10 comprises a mixing device 11 designed as a Schottky diode 11 which is designed to mix the received radio signal FS with itself. The mixed is radio signal gem(FS) is then demodulated by an AM demodulator 12, e.g. by a detector receiver 12, and passed onto an address decoder 13 as a demodulated radio signal demod(FS). The address decoder 13 issues a wake-up signal WS when the demodulated radio signal demod(FS) displays a predefined address code.

In further embodiments, the demodulator 13 is designed as an FM demodulator 13, e.g. as a discriminator 13. In yet further embodiments, the demodulator 13 is designed as any demodulator 13 which is suited to demodulating the demodulated radio signal (FS) in order to obtain the information contained in the information signal IS.

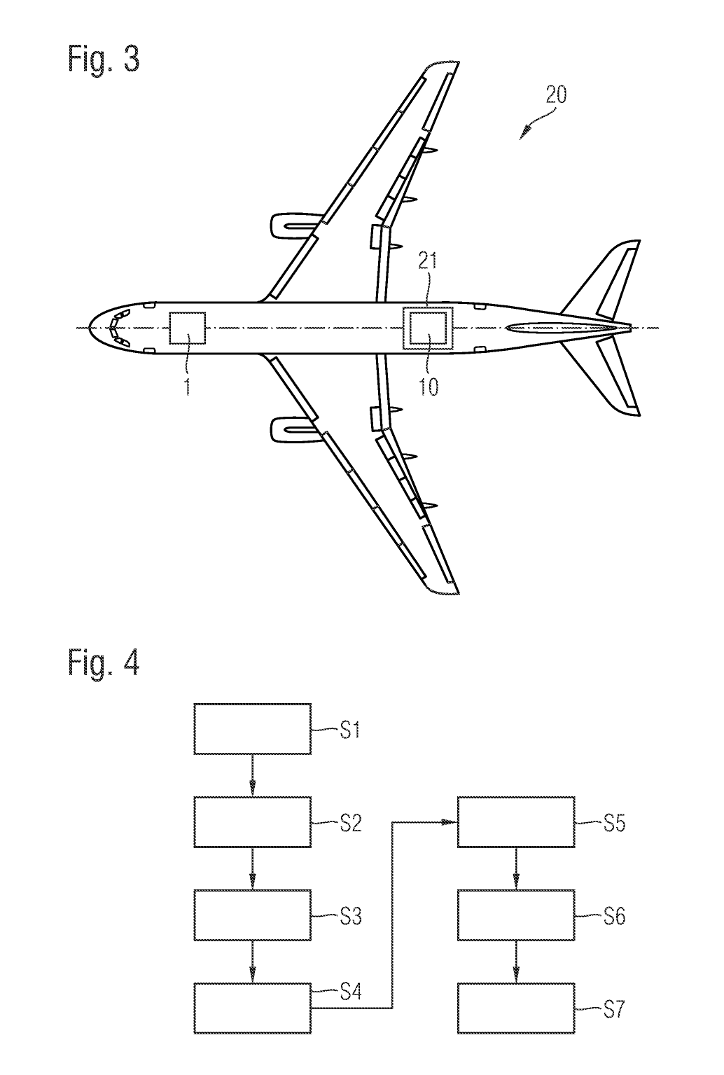

FIG. 3 shows a block diagram of an embodiment of an aircraft and/or spacecraft 20 according to the invention.

An aircraft and/or spacecraft 20 in FIG. 3 is designed as an aircraft 20 which comprises a transmitter 1 and an electronic system 21. The electronic system 21 also comprises a receiver 10 which is designed to wake up the electronic system 21 when the receiver 10 receives an appropriate radio signal FS from the transmitter 1.

In further embodiments, the aircraft 20 may comprise more than one electronic system 21. For example, the aircraft 20 may comprise an electronic system 21 at each seat.

In further embodiments, the aircraft and/or spacecraft 20 may be designed as a spacecraft 20, e.g. as a rocket 20.

Application in a land or water vehicle is also conceivable instead of application is in an aircraft or spacecraft.

FIG. 4 shows a flow chart for an embodiment of a method according to the invention.

In the method according to the invention a transmitter 1 according to the invention is provided at S1. A receiver 10 according to the invention is provided at S2. Then, a carrier signal TS and a modulated information signal mod(IS, TS) are emitted at S3. The emitted radio signal FS which comprises the emitted carrier signal TS and the modulated information signal mod(IS, TS) is received by a receiver 10 at S4. The received radio signal FS is then mixed with itself at S5. The radio signal gem(FS) which has been mixed with itself is demodulated at S6. At S7 the demodulated radio signal demod(FS) is compared with a predefined address code and a wake-up signal WS is emitted if the demodulated radio signal demod(FS) displays the predefined address code.

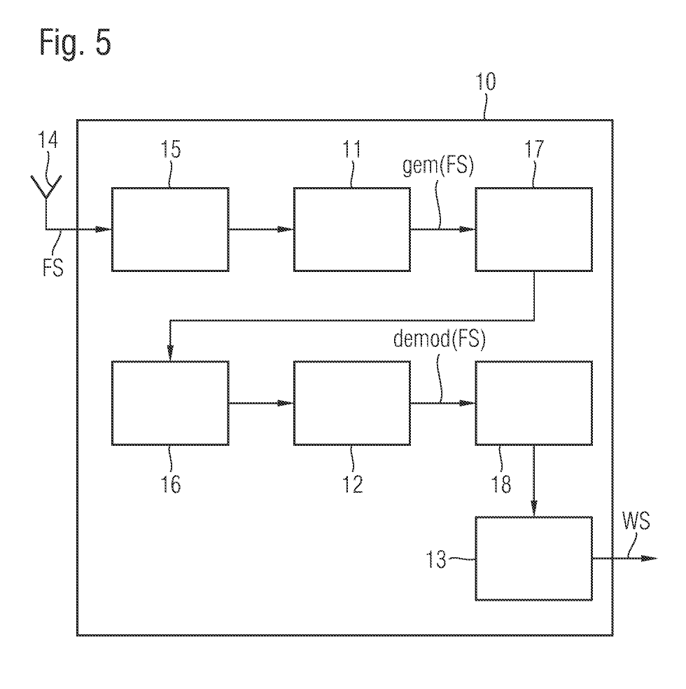

FIG. 5 shows a block diagram of a further embodiment of a receiver 10 according to the invention.

The receiver 10 in FIG. 5 differs from the receiver in FIG. 1 in that an antenna 14 and a first filter 15 connected in series after the antenna 14 are provided before the mixing device 11. In this case, the antenna 14 is adapted for the frequency range in which the carrier signal TS and the single-sideband modulated information signal mod(IS, TS) are located. In FIG. 5 the filter 15 is designed as a band-pass filter 15 which is also adapted to allow the passage of signals in the frequency range in which the carrier signal TS and the single-sideband modulated information signal mod(IS, TS) are located. A first amplifier 17 is provided after the mixing device 11 in FIG. 5, this amplifier amplifying the radio signal gem(FS) mixed with itself and passing it to a is second filter 16. The second filter 16 is designed as a highly frequency-selective filter 16 which is adapted for the second frequency, i.e. the frequency of the original information signal IS. This thus reduces noise and extraneous signals in the mixed radio signal gem(FS). Finally, a second amplifier 18 is provided after the demodulator 12, this amplifier amplifying the demodulated radio signal demod(FS) in such a way that this can be processed by the address decoder 13.

Although the present invention has been described here by preferred embodiments, it is not limited to the above, but rather may be modified in multiple ways.

For example, the present invention may be used in vehicles other than aircraft and spacecraft. The present invention may be used in ships, motor vehicles and rail vehicles, by way of example.

What is claimed is:

1. A transmitter for waking up electronic systems, comprising:
a first signal generator which is designed to generate a carrier signal with a first frequency;
a second signal generator which is designed to generate an information signal with a second frequency;
a single-sideband modulator which is designed to modulate the information signal by the carrier signal and to provide this as a modulated information signal; and
a transmission device which is designed to emit the generated carrier signal and the modulated information signal.

2. The transmitter according to claim 1, wherein the second signal generator is designed to generate the information signal at least in accordance with an address code and/or a channel number and/or a time slot number and/or an access code.

3. The transmitter according to claim 1, wherein the second signal generator is designed to generate the information signal by frequency modulation and/or amplitude modulation and/or an analogue modulation method and/or a digital modulation method.

4. A receiver for electronic systems, comprising:
a mixing device which is designed to mix a received radio signal with itself and to emit a mixed radio signal;
a demodulator which is designed to demodulate the emitted mixed radio signal and to emit a demodulated radio signal; and
an address decoder which is designed to compare the demodulated radio signal with a predefined address code and to emit a wake-up signal if the demodulated radio signal displays the predefined address code.

5. The receiver according to claim 4, wherein the mixing device comprises a non-linear electrical component and/or a diode, and in particular a Schottky diode, and/or a field-effect transistor with one input and/or a field-effect transistor with two inputs.

6. The receiver according to claim 4, wherein an antenna for receiving the radio signal is provided, this radio signal comprising a carrier signal with a first frequency and an information signal with a second frequency modulated by the carrier signal using single-sideband modulation, and a first filter connected in series with the antenna in front of the mixing device, this filter filtering the is received radio signal in such a way that the received filtered radio signal at least comprises the carrier signal and the single-sideband modulated information signal.

7. The receiver according to claim 4, wherein a second filter is provided between the mixing device and the demodulator, this filter being designed to filter the mixed radio signal in such a way that a filtered radio signal at least comprises the information signal at the second frequency.

8. The receiver according to claim 4, wherein a first amplifier is also provided between the mixing device and the demodulator, this amplifier being designed to amplify the mixed radio signal.

9. The receiver according to claim 4, wherein a second amplifier is provided between the demodulator and the address decoder, this amplifier amplifying the demodulated radio signal in such a way that the demodulated radio signal can be evaluated by the address decoder.

10. An aircraft or spacecraft with at least one transmitter wherein the transmitter comprises:
a first signal generator which is designed to generate a carrier signal with a first frequency;
a second signal generator which is designed to generate an information signal with a second frequency;
a single-sideband modulator which is designed to modulate the information signal by the carrier signal and to provide this as a modulated information signal; and
a transmission device which is designed to emit the generated carrier signal and the modulated information signal; and
is at least one electronic system which comprises a receiver according to claim 4.

11. A method for waking up an electronic system, the method comprising:
providing a transmitter comprising:
a first signal generator which is designed to generate a carrier signal with a first frequency;
a second signal generator which is designed to generate an information signal with a second frequency;
a single-sideband modulator which is designed to modulate the information signal by the carrier signal and to provide this as a modulated information signal; and
a transmission device which is designed to emit the generated carrier signal and the modulated information signal; and
providing a receiver comprising:
a mixing device which is designed to mix a received radio signal with itself and to emit a mixed radio signal;
a demodulator which is designed to demodulate the emitted mixed radio signal and to emit a demodulated radio signal; and
an address decoder which is designed to compare the demodulated radio signal with a predefined address code and to emit a wake-up signal if the demodulated radio signal displays the predefined address code;
emitting a carrier signal and a single-sideband modulated information signal;
receiving a radio signal which comprises the emitted carrier signal and the modulated information signal;
mixing the received radio signal with itself;
is demodulating the radio signal which has been mixed with itself; and
comparing the demodulated radio signal with a predefined address code and emission of a wake-up signal if the demodulated radio signal displays the predefined address code.

12. The method according to claim 11, in which the radio signal comprises a carrier signal with a first frequency and an information signal with a second frequency modulated by the carrier signal using single-sideband modulation, and in which the received radio signal is filtered after reception in such a way that the received filtered radio signal at least comprises the carrier signal and the single-sideband modulated information signal.

13. The method according to claim 11, in which, after the received radio signal has been mixed with itself, the mixed radio signal is filtered in such a way that the filtered radio signal at least comprises the information signal with the second frequency.

14. The method according to claim 11, in which the mixed radio signal is amplified.

15. The method according to claim 11, in which after demodulation of the radio signal which has been mixed with itself, the demodulated radio signal is amplified in such a way that the demodulated radio signal can be evaluated by an address decoder.
